(19) United States
(12) Patent Application Publication
(10) Pub. No.: US 2025/0031899 A1
(43) Pub. Date: Jan. 30, 2025

(54) MACHINE AND METHOD FOR PREPARING A BREWED DRINK

(71) Applicant: Melitta Single Portions GmbH & Co. KG, Minden (DE)

(72) Inventors: Jan PAHNKE, Minden (DE); Christopher ZUM BRUCH, Köln (DE)

(73) Assignee: Melitta Single Portions GmbH & Co. KG, Minden (DE)

(21) Appl. No.: 18/715,226

(22) PCT Filed: Nov. 15, 2022
(86) PCT No.: PCT/EP2022/081914

§ 371 Date: May 31, 2024

(30) Foreign Application Priority Data
Dec. 7, 2021 (DE) 10 2021 132 207.3

(51) Int. Cl. A47J 31/52; A47J 31/40

(52) U.S. Cl. CPC A47J 31/525; A47J 31/407

(57) ABSTRACT

A machine for the preparation of a brewed beverage includes a device for the generation of hot water, with a supply line for dispensing the hot water, a holder for a portion pack with an extraction material, the holder being arranged below the supply line, a controller and a recognition unit with an optical sensor connected to the controller, the brewing procedure being controllable dependent on the detection of a color change by the optical sensor. In a method for the preparation of a brewed beverage, a color change is used to control the brewing procedure.

The present invention relates to a machine for the preparation of a brewed beverage with a device for the generation of hot water, with a supply line for dispensing the hot water, a holder for a portion pack with an extraction material, the holder being arranged below the supply line, a controller and a recognition unit with an optical sensor connected to the controller, and a method for the preparation of a brewed beverage with the following steps: Inserting a portion pack with an extraction material into a holder of a machine for the preparation of a brewed beverage, opening the portion pack, introducing hot water via a supply line onto the extraction material in the portion pack for the preparation of a brewed beverage.

WO 2019/141871 discloses a portion pack comprising a container of filter material in which an extraction material is arranged. The portion pack can be opened automatically in a machine for the preparation of a brewed beverage in order to then dispense hot water onto the extraction material in the portion pack. For such portion packs, it is known to provide a recognition unit so that a certain type of portion pack is recognised, for example to be able to set the brewing quantity or the brewing temperature or other parameters during beverage preparation. A disadvantage of preparing a brewed beverage with such a portion pack is that the sequence of the individual process steps during preparation is insufficiently detected. For example, if the opening is inadequate, a supply of hot water can flow without completely wetting the extraction material. In addition, errors in detection can lead to undesired programme sequences, which can also increase the risk of injury, for example due to the undefined discharge of hot water.

It is therefore the problem to be solved by the present invention to provide a machine and a method for the preparation of a brewed beverage which enable more precise monitoring of the brewing process during the preparation of a brewed beverage.

This problem is solved by a machine with the features of claim 1 and a method with the features of claim 9.

In the machine according to the invention, the recognition unit includes an optical sensor, and the brewing procedure can be controlled depending on the detection of a colour change by the optical sensor. This enables timely monitoring of the brewing procedure, as the brewing procedure can be controlled depending on the detection of a predetermined colour change by the sensor. For example, safety can also be increased if the sensor prevents an inflow of hot water via the supply line upon detection of an already brewed portion pack in which the surface of the brewed extraction material has a predetermined colour. The optical detection can thus be used to prevent hot water from being fed onto an already brewed portion pack.

Preferably, the portion pack comprises a cover layer of water-soluble material, whereby a colour change during the brewing procedure can be detected via the optical sensor. This allows the brewing process to be monitored more precisely in order to be able to detect a colour change due to at least partial dissolution of the cover layer. This makes it possible to distinguish more precisely between an already brewed portion pack and an unbrewed portion pack and to recognise the stage of the brewing process at which the portion pack is located.

For good positioning, the optical sensor can be fixed to the supply line, which is arranged above the portion pack at least during the brewing procedure. The optical sensor can include a light source, for example an LED, so that light is reflected when the top side of the portion pack is illuminated. If the cover layer is still present, the light is reflected by the cover layer, while after the cover layer has dissolved, the light is reflected by the extraction material, which can be detected as a colour change.

The cover layer preferably includes milk powder, in particular white milk powder, which contrasts significantly with the dark extraction material, in particular coffee powder. Alternatively or additionally, the cover layer may include sugar, which also has a light colour and is optically different from the dark extraction material. Instead of coffee powder, the extraction material can also be tea.

Preferably, the supply line is moveable via a drive, and a surface of the extraction material with the cover layer can be wetted with hot water when the supply line is moved. This allows a larger area of a surface of the extraction material to come into direct contact with the hot water from the supply line, which makes it easier to dissolve the cover layer at the start of the brewing process. The supply line can be moved over the surface in a programme-controlled manner in order to wet as many areas of the surface as possible with hot water.

In a further embodiment, the recognition unit includes at least one further sensor, in particular a proximity sensor. A first shape of a portion pack and a second shape of the portion pack, which is different from the first shape, can be detected contactless via the proximity sensor. This allows different shapes of the portion pack to be monitored. The first and second shapes of the portion pack can correspond to different states, for example the first shape can correspond to a closed state of the portion pack, while a second shape corresponds to an open state in which closure elements have been moved, for example by pivoting. Such a proximity sensor can detect the outer shape of the portion pack in a contactless manner. Capacitive sensors are suitable for this purpose. Alternatively, other proximity sensors can also be used, such as light barriers or ultrasonic sensors. Optionally, only a single sensor can be used with the optical sensor to detect a colour change and a change in the shape of the portion pack.

In the method according to the invention, a portion pack with an extraction material and a cover layer is first inserted into a holder of a machine for the preparation of a brewed beverage, wherein the portion pack is either already open or is opened in this step and hot water is then introduced via a supply line onto the extraction material in the portion pack for the preparation of a brewed beverage. The portion pack comprises a cover layer of water-soluble material, and a colour change during the brewing procedure can be detected via an optical sensor of a recognition unit. This allows the brewing procedure to be monitored more closely and, in particular, to determine whether the extraction material in the portion pack has already undergone a brewing process or not.

Preferably, the optical sensor can be used to detect whether an already used portion pack is located under the supply line, so that the controller can then be used to block the dispensing of hot water.

The colour change on a cover layer of the portion pack can be generated by mixing two layers, in particular after the addition of hot water. Alternatively or additionally, the colour change on a cover layer of the portion pack can be generated by thermochromatic transfer. It is also possible for the colour change to be generated on a cover layer of the portion pack by a component becoming transparent.

The invention is explained in more detail below with reference to the attached drawing. It is shown in:

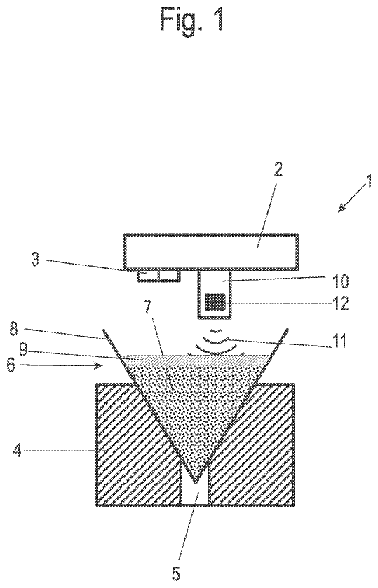

FIG. 1 a schematic view of a machine according to the invention for the preparation of a brewed beverage.

A machine 1 for the preparation of a brewed beverage includes a supply line 2 for hot water, which is connected to a device for pumping and heating water, for example from a tank or to a water pipe. The machine includes a controller by means of which the dispensing of hot water and, optionally, the temperature of the hot water at the supply line 2 can be controlled.

An outlet 3 is provided on the supply line 2, which is arranged above a holder 4 for holding a portion pack 6. The holder 4 includes an outlet opening 5 through which the brewed beverage can be dispensed to another vessel, for example a coffee pot or a cup.

The portion pack 6 includes a sleeve of filter material in which an extraction material 7, in particular coffee powder or tea, is arranged. A cover layer 9 is arranged on a top side of the extraction material 7.

The portion pack includes a plurality of closure elements 8 on a top side, which can be pivoted between a closed position of the portion pack 6 and an open position. The portion pack 6 can be formed as disclosed in DE 10 2018 101 337, to which reference is hereby made. Optionally, the portion pack 6 can also already be inserted into a holder in an upwardly open position.

An optical sensor 10 is fixed to the supply line 2, via which a colour change on the top side of the portion pack 6 can be detected. The optical sensor preferably comprises a light source by means of which light is emitted onto the top side of the portion pack 6, as shown schematically with the lines 11. The reflected light can then be detected by the optical sensor. An optional display 12, for example a colour LED or other display means, can be provided on the optical sensor 10 in order to visualise the optical detection.

In the unbrewed state, the top side of the portion pack 6 comprises the cover layer 9 made of water-soluble material. This cover layer 9 may, for example, contain milk powder and/or sugar which have a different colour than the underlying extraction material 7, in particular coffee powder. This makes it easy to detect an unbrewed state of the portion pack 6.

During the brewing procedure, hot water is applied to the cover layer 9 via the supply line 2 and the outlet 3, so that the water-soluble material is dissolved and removed from the top side of the extraction material 7. After the brewing procedure, the top side of the extraction material 7 is thus at least partially, preferably predominantly, freed from the cover layer 9, which is detected as a colour change via the optical sensor 10. If the already brewed portion pack 6 is forgotten to be removed from the holder 4 before the next brewing procedure is initiated, the controller can be used to block the dispensing of hot water at the outlet 3.

Preferably, the supply line 2 is arranged to be moveable so that the surface of the portion pack can be wetted with hot water in strips rather than just at specific points. The supply line 2 can be moved in certain patterns under programme control, in particular in a horizontal direction, in order to wet the top side as completely as possible with hot water. After the brewing procedure, the supply line 2 can optionally be removed from above the portion pack so that the portion pack 6 can be more easily removed from the holder 4 and a new portion pack 6 can be inserted. The movement of the optical sensor also allows multiple measuring points, which increases reliability.

1. A machine (1) for preparation of a brewed beverage comprising:
a device configured for generation of heated water, with a supply line (2) configured for dispensing the heated water,
a holder (4) configured for holding a portion pack (6) with an extraction material (7), wherein the holder (4) is arranged below the supply line (2),
a controller, and
a recognition unit with an optical sensor connected to the controller, wherein the controller is configured for controlling a brewing procedure dependent on detection of a color change by the optical sensor (10).

2. The machine according to claim 1, wherein the portion pack (6) comprises a cover layer (9) of water-soluble material and wherein the optical sensor (10) is configured to detect a color change in the cover layer (9) during the brewing procedure.

3. The machine according to claim 1, wherein the optical sensor (10) is fixed to the supply line (2).

4. The machine according to claim 1, wherein a cover layer (9) in the portion pack comprises milk powder.

5. The machine according to claim 1, wherein a cover layer (9) in the portion pack includes sugar.

6. The machine according to claim 1, wherein the supply line (2) is moveable via a drive and a surface of the extraction material (7) with the cover layer (9) is wettable with the heated water when the supply line (2) is moved.

7. The machine according to claim 1, wherein the recognition unit comprises at least one further sensor.

8. The machine according to claim 7, wherein the further sensor is a proximity sensor that is configured to detect in a contactless manner a first shape of the portion pack (6) and a second shape of the portion pack (6), which is changed from the first shape.

9. A method for the preparation of a brewed beverage comprising the following steps:
inserting a portion pack (6) with an extraction material (7) into a holder (4) of a machine (1) for the preparation of the brewed beverage;
supplying heated water via a supply line (2) onto the extraction material (7) in the portion pack for the preparation of the brewed beverage, and controlling the brewing procedure via a controller and a recognition unit with an optical sensor (10) connected to the controller, dependent on the detection of a color change by the optical sensor (10).

10. The method according to claim 9, wherein the portion pack (6) comprises a cover layer (9) of water-soluble material and a color change in the cover layer (9) during the brewing procedure is detected via the optical sensor (10).

11. The method according to claim 9, wherein the portion pack (6) contains a cover layer (9) of water-soluble material with milk powder and/or sugar and wherein the controller prevents dispensing of the heated water when a brewed portion pack (6) is detected via the optical sensor (10).

12. The method according to claim 10, wherein the color change on the cover layer (9) of the portion pack (6) is generated by mixing two layers.

13. The method according to claim 10, wherein the color change on the cover layer (9) of the portion pack (6) is generated by thermochromatic wrapping.

14. The method according to claim 10, wherein the color change on the cover layer (9) of the portion pack (6) is generated by a component becoming transparent.
